(19) United States
(12) Patent Application Publication
(10) Pub. No.: US 2025/0389851 A1
(43) Pub. Date: Dec. 25, 2025

(54) STATE-SPACE REPRESENTATION (SSR) PRECISE POSITIONING ENGINE (PPE) WITH DISCONTINUOUS CORRECTIONS

(71) Applicant: QUALCOMM Incorporated, San Diego, CA (US)

(72) Inventor: Min WANG, Tustin, CA (US)

(21) Appl. No.: 18/748,592

(22) Filed: Jun. 20, 2024

(51) Int. Cl. G01S 19/44; G01S 19/07

(52) U.S. Cl. CPC G01S 19/44; G01S 19/07

(57) ABSTRACT

In some implementations, a global navigation satellite system (GNSS) device may include perform a carrier phase measurement of a radio frequency (RF) signal transmitted in a frequency band by a GNSS satellite at a first epoch and obtain a first set of SSR corrections applicable to the frequency band and the GNSS satellite at the first epoch. The device may determine a correction discontinuity based on a comparison of the first set of SSR corrections to a second set of SSR corrections applicable to the frequency band and the GNSS satellite at an epoch previous to the first epoch. Moreover, the device may determine a measurement adjustment for the carrier phase measurement to compensate for the correction discontinuity. Also, the device may output an indication of a position estimate of the GNSS device corresponding to the first epoch based on the measurement adjustment for the carrier phase measurement.

### BACKGROUND

### 1. Field of Disclosure

The present disclosure relates generally to the field of mobile device positioning using radio frequency (RF) signals and, more specifically, to global navigation satellite system (GNSS)-based positioning.

### 2. Description of Related Art

The global navigation satellite system (GNSS) is widely used for positioning consumer electronic devices such as smartphones, as well as for positioning vehicles such as cars, trucks, ships, and aircraft. High-accuracy positioning can provide significant value to various modern-day positioning-based applications. For example, an autonomous driving application may benefit from meter-level positioning information that enables it to determine which particular lane of a road an autonomously driven vehicle is in and may further benefit from sub-meter-level positioning information that enables it to determine where that vehicle is located within the lane.

High-accuracy positioning of a mobile device may involve the use of a precise positioning engine (PPE) at the mobile device to generate high-accuracy positioning information based on GNSS measurements and error correction data. The error correction data may be received at the mobile device and may be in a format such as State-Space Representation (SSR). The mobile device may use SSR correction data for all GNSS satellites and frequency bands for which it obtained GNSS measurements, and the high-accuracy positioning information (e.g., position estimate of the mobile device) can be based on the GNSS measurements, corrected by the corresponding SSR correction data.

### BRIEF SUMMARY

An example method of discontinuous State-Space Representation (SSR) correction handling in global navigation satellite system (GNSS)-based positioning, according to this disclosure, comprises performing, with a GNSS device, a carrier phase measurement of a radio frequency (RF) signal transmitted in a frequency band by a GNSS satellite at a first epoch. The method further comprises obtaining, at the GNSS device, a first set of SSR corrections, the first set of SSR corrections comprising one or more SSR corrections applicable to the frequency band and the GNSS satellite at the first epoch. The method further comprises determining, with the GNSS device, a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch. The method also comprises determining, with the GNSS device, a measurement adjustment for the carrier phase measurement, the measurement adjustment to compensate for the correction discontinuity, and outputting an indication of a position estimate of the GNSS device corresponding to the first epoch, wherein the position estimate of the GNSS device corresponding to the first epoch is based at least in part on the measurement adjustment for the carrier phase measurement.

An example global navigation satellite system (GNSS) device, according to this disclosure, comprises one or more GNSS receivers, one or more memories, and one or more processors communicatively coupled with the one or more GNSS receivers and the one or more memories. The one or more processors are configured to perform, with the one or more GNSS receivers, a carrier phase measurement of a radio frequency (RF) signal transmitted in a frequency band by a GNSS satellite at a first epoch. The one or more processors are also configured to obtain a first set of State-Space Representation (SSR) corrections, the first set of SSR corrections comprising one or more SSR corrections applicable to the frequency band and the GNSS satellite at the first epoch. The one or more processors are further configured to determine a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch. The one or more processors are also configured to determine a measurement adjustment for the carrier phase measurement, the measurement adjustment to compensate for the correction discontinuity. The one or more processors are also configured to output an indication of a position estimate of the GNSS device corresponding to the first epoch, wherein the position estimate of the GNSS device corresponding to the first epoch is based at least in part on the measurement adjustment for the carrier phase measurement.

An example apparatus for discontinuous State-Space Representation (SSR) correction handling in global navigation satellite system (GNSS)-based positioning, according to this disclosure, comprises means for performing a carrier phase measurement of a radio frequency (RF) signal transmitted in a frequency band by a GNSS satellite at a first epoch. The apparatus further comprises means for obtaining a first set of SSR corrections, the first set of SSR corrections comprising one or more SSR corrections applicable to the frequency band and the GNSS satellite at the first epoch. The apparatus also comprises means for determining a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch. The apparatus also comprises means for determining a measurement adjustment for the carrier phase measurement, the measurement adjustment to compensate for the correction discontinuity. The apparatus further comprises means for outputting an indication of a position estimate of a GNSS device corresponding to the first epoch, wherein the position estimate of the GNSS device corresponding to the first epoch is based at least in part on the measurement adjustment for the carrier phase measurement.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system in which a mobile device (e.g., a global navigation satellite system (GNSS) device) can use the techniques provided herein for precise positioning with State-Space Representation (SSR) correction data discontinuity handling, according to an embodiment.

FIG. 2 is a simplified diagram of a GNSS system, according to an embodiment.

FIG. 3 is a table of correction data that can be used by a precise positioning engine (PPE) for high-precision position estimates, according to embodiments herein.

FIG. 4 is an illustration of two graphs illustrating discontinuities in SSR correction data in an example data set.

FIG. 5 is an illustration of graphs that illustrate an example of degradation in PPE performance due to a discontinuity in SSR correction data, based on simulated results.

FIG. 6 is an illustration of graphs, corresponding to graphs in FIG. 5, that illustrate increased PPE performance due to handling discontinuity in SSR correction data in the manner provided in the embodiments herein.

FIG. 7 is a flow diagram of a method of discontinuous SSR correction handling in GNSS-based positioning, according to an embodiment.

FIG. 8 is a block diagram of an embodiment of a GNSS device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples in which one or more aspects of the disclosure may be implemented are described below, other examples may be used, and various modifications may be made without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification do not necessarily refer to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. Further, a “GNSS device” as used herein, may refer to an electronic device (e.g., mobile device or UE as described above) with circuitry and/or components capable of performing GNSS measurements and determining a GNSS position. As referred to herein, a “GNSS receiver” may refer to such circuitry and/or components or may generically refer to a GNSS device. According to some embodiments, A GNSS device comprising a mobile device and/or UE may be capable of sending and/or receiving data over a wireless communications network. Such a device may be stationary (e.g., permanently or temporarily) or mobile, and may communicate with a Radio Access Network (RAN). Generally put, communication by devices herein may be performed via a cellular network (e.g., via a core network via a RAN, and through the core network). The cellular network may be connected with external networks (such as the Internet) and with other devices. Other mechanisms of connecting to the Internet and/or other data networks are also possible for the devices described herein, such as over wireless local area network (WLAN) networks (e.g., based on the Institute of Electrical and Electronics Engineers (IEEE) 802.11 standard, etc.), and/or the like.

A “space vehicle” (SV) as referred to herein, relates to an object that is capable of transmitting signals to receivers (e.g., GNSS receivers/GNSS devices) on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

As previously noted, a GNSS device may be able to accurately estimate its position using measurements of GNSS signals transmitted on different GNSS frequency bands by multiple different GNSS satellites, along with correction data corresponding to those frequency bands and satellites. In particular, a precise positioning engine (PPE) executed by the mobile device may perform GNSS positioning using a high-precision GNSS positioning technique, such as precise point positioning (PPP) or real-time kinematic (RTK) positioning, by performing error correction on GNSS measurements taken at the mobile device. State-space representation (SSR) is a type of correction data that may be used in such positioning.

SSR may be particularly advantageous over alternatives such as observation-space representation (OSR) because each error component may be represented individually rather than using “lump sum” error correction. This means that some error correction may be performed if the mobile device can only obtain a portion of the error components. Moreover, some SSR error components may be provided for free, whereas OSR error correction may require a paid service.

The use of SSR may, however, have some drawbacks. Some types of SSR correction may have discontinuities, or “jumps,” in correction values at certain times. If not properly handled by a PPE, these discontinuities can cause significant degradation in the accuracy of the PPE's position estimate.

Embodiments address these and other issues by providing correction data discontinuity handling. Some aspects more specifically relate to reducing or removing any degradation in position accuracy by compensating for error correction discontinuities in corresponding carrier phase measurements. In some examples, a GNSS device may observe a discontinuity in the SSR correction data for a certain frequency band and satellite at one epoch based on a comparison of the SSR correction data with corresponding SSR correction data for the certain frequency band and satellite for a previous epoch. In some embodiments, SSR correction data may be projected onto a line of sight (LOS) vector between the position of the GNSS satellite and the approximate position of the GNSS device, and a discontinuity in the SSR correction data may be determined if a value of the SSR correction data between epochs (e.g., measured in distance) jumps by at least a threshold amount. According to some aspects, once a discontinuity is identified, a corresponding carrier phase measurement may be adjusted to compensate for the discontinuity. This can include, for example, adjusting an ambiguity term or a cumulative correction term of the carrier phase measurement.

Particular aspects of the subject matter described in this disclosure can be implemented to realize one or more of the following potential advantages. In some examples, by compensating for discontinuity in error correction data, the described techniques can be used to provide a more robust PPE capable of maintaining accuracy when exposed to such discontinuities. These and other advantages will be apparent to a person of ordinary skill in the art in view of the embodiments described below.

Various embodiments are provided in detail hereafter, following a review of applicable technology.

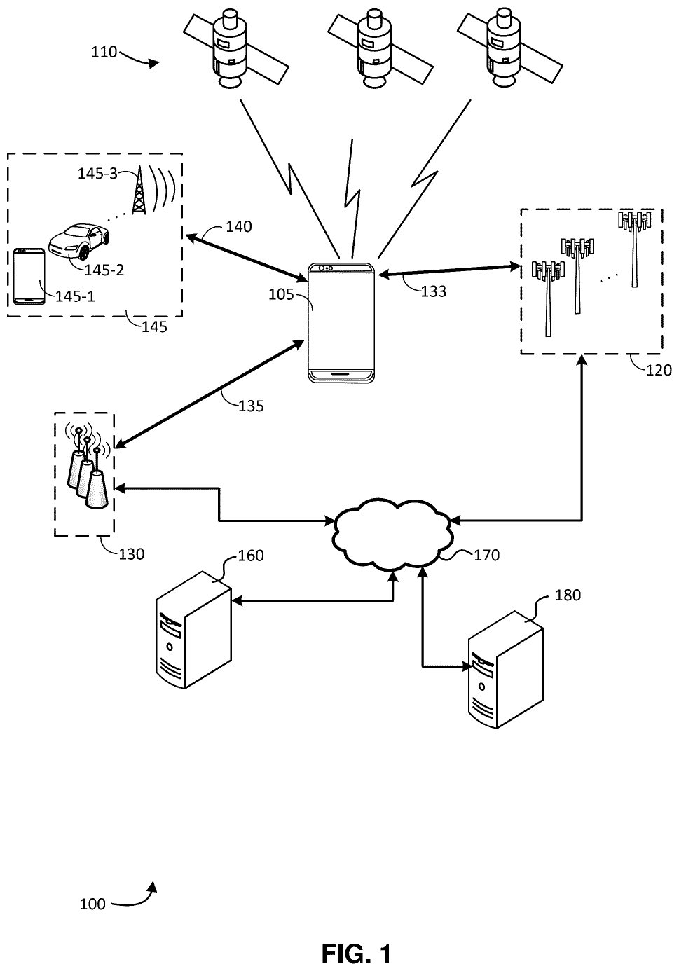

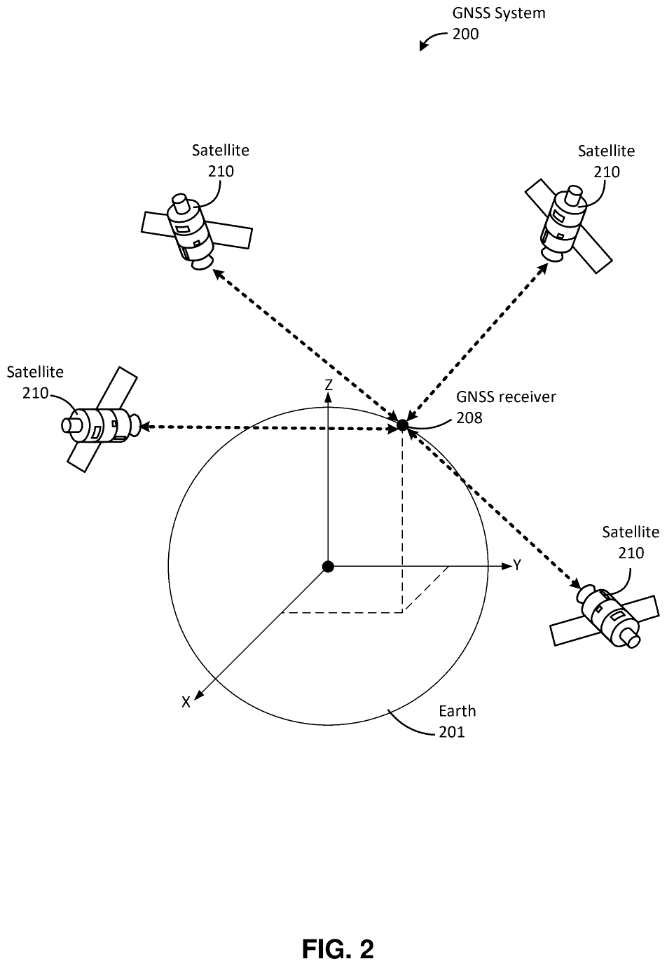

FIG. 1 is a simplified illustration of a positioning system 100 in which a mobile device 105, location server 160, and/or other components of the positioning system 100 can use the techniques provided herein for precise positioning with SSR correction data discontinuity handling, according to an embodiment. The techniques described herein may be implemented by one or more components of the positioning system 100. The positioning system 100 can include a mobile device 105; one or more satellites 110 (also referred to as space vehicles (SVs)) for a GNSS such as the global positioning system (GPS), GLONASS (GLO), Galileo (GAL), or BeiDou Navigation Satellite System (BDS); base stations 120; access points (APs) 130; location server 160; network 170; and external client 180. Generally put, the positioning system 100 can estimate the location of the mobile device 105 based on radio frequency (RF) signals received by and/or sent from the mobile device 105 and known locations of other components (e.g., GNSS satellites 110, base stations 120, APs 130) transmitting and/or receiving the RF signals. Additional details regarding particular location estimation techniques are discussed in more detail with regard to FIG. 2.

In this example, FIG. 1 illustrates the mobile device 105 as a smartphone device. However, mobile devices capable of performing the techniques described herein may be any suitable device that includes GNSS capabilities or may be a device or machine into which such GNSS capabilities are integrated. Thus, a mobile device 105 may include personal devices such as a smartphone, smartwatch, tablet, laptop, etc. However, mobile devices may include a larger class of devices as well and may include vehicles with integrated GNSS receivers and positioning systems, such as boats or ships, cars, trucks, aircraft, shipping containers, etc. As noted, in certain contexts, such as in reference to a cellular network, the mobile device 105 may be referred to as a UE.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (cNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (cMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with the known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, and/or static communication/positioning device 145-3. When or more other mobile devices 145 are used in the position determination of a particular mobile device 105, the mobile device 105 for which the position is to be determined may be referred to as the “target mobile device,” and each of the one or more other mobile devices 145 used may be referred to as an “anchor mobile device.” For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond with a component or device on a vehicle, RSU, or other V2X entity that is used to communicate V2X messages. The static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, cast or west and possibly above or below some other known fixed location (including, e.g., the location of a base station 120 or AP 130) or some other location such as a location for mobile device 105 at some known previous time, or a location of another mobile device 145 at some known previous time). As noted elsewhere herein, a location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as a friend or relative finder, or child or pet location). Additionally or alternatively, the external client 180 may obtain and provide the location of mobile device 105 to an emergency services provider, government agency, etc.

As noted, the mobile device 105 of FIG. 1 may be capable of GNSS positioning. Details regarding the GNSS positioning of a mobile device 105, or any device comprising a GNSS receiver, are provided hereafter with regard to FIG. 2.

FIG. 2 is a simplified diagram of a GNSS system 200, provided to illustrate how GNSS is generally used to determine an accurate location of a GNSS receiver 208 on earth 201. Put generally, the GNSS system 200 enables an accurate GNSS position fix of the GNSS receiver 208, which receives RF signals from GNSS satellites 210 (which may correspond with satellites 110 of FIG. 1) from one or more GNSS constellations. The types of GNSS receiver 208 used may vary, depending on the application. In some embodiments, for instance, the GNSS receiver 208 may comprise a standalone device or component incorporated into another device (e.g., mobile device 105 of FIG. 1). In some embodiments, the GNSS receiver 208 may be integrated into industrial or commercial equipment, such as survey equipment, Internet of Things (IoT) devices, etc.

It will be understood that the diagram provided in FIG. 2 is greatly simplified. In practice, there may be dozens of satellites 210 in a given GNSS constellation, and many different types of GNSS systems with corresponding constellations. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, determining the position of a GNSS receiver 208 in three dimensions may rely on determining the distance between the GNSS receiver 208 and four or more satellites 210. As illustrated, 3D coordinates may be based on a coordinate system (e.g., Cartesian coordinates in the format of X, Y, and Z; geographic coordinates in the format of latitude, longitude, and altitude; etc.) centered at the earth's center of mass. A distance between each satellite 210 and the GNSS receiver 208 may be determined using precise measurements made by the GNSS receiver 208 of a difference in time from when an RF signal is transmitted from the respective satellite 210 to when it is received at the GNSS receiver 208. To help ensure accuracy, not only does the GNSS receiver 208 need to accurately determine when the respective signal from each satellite 210 is received, but many additional factors need to be considered and accounted for. These factors include, for example, clock differences at the GNSS receiver 208 and satellite 210 (e.g., clock bias), a precise location of each satellite 210 at the time of transmission (e.g., as determined by the broadcast ephemeris), the impact of atmospheric distortion (e.g., ionospheric and tropospheric delays), and the like.

To perform a traditional GNSS position fix, the GNSS receiver 208 can use code-based positioning to determine its distance to each satellite 210 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 210, the GNSS receiver 208 can then determine a position fix for its location. This position fix may be determined, for example, by a Standalone Positioning Engine (SPE) executed by one or more processors of the GNSS receiver 208. However, code-based positioning is relatively inaccurate and, without error correction, and is subject to many of the previously described errors. Even so, code-based GNSS positioning can provide a positioning accuracy for the GNSS receiver 208 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 210 observed by the GNSS receiver 208 can be mitigated or canceled based on similar carrier-based ranging of the satellites 210 using a highly accurate GNSS receiver at the base station at a known location. These measurements and the base station's location can be provided to the GNSS receiver 208 for error correction. This position fix may be determined, for example, by a Precise Positioning Engine (PPE) executed by one or more processors of the GNSS receiver 208. More specifically, in addition to the information provided to an SPE, the PPE may use base station GNSS measurement information and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 2, the satellites 210 may be members of a single satellite constellation, i.e., a group of satellites that are part of a GNSS system, e.g., controlled by a common entity such as a government, and orbiting in complementary orbits to facilitate determining positions of entities around the world. One or more of the satellites 210 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example L2 and L5 bands. As another example, a receiver may use separate receive chains for different signals in the same band, for example GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

As previously noted, precise positioning (e.g., RTK or PPP positioning) may utilize error correction provided by an error correction service. Error correction is typically provided using SSR or OSR. As previously noted, OSR utilizes a format in which a “lump sum” of error components for carrier phase and pseudorange measurements are provided, typically from a local physical reference station positioning reference signal (PRS). SSR, on the other hand, provides correction of individual error components, such as orbit, clock, and differential code bias (DCB). When SSR transmits enough information, the accuracy of resulting positioning estimates based on SSR can be comparable to the accuracy achieved using OSR. Furthermore, free SSR (with regional or global coverage) is often available for at least some GNSS frequency bands from services such as Quasi-Zenith Satellite System (QZSS) Centimeter Level Augmentation Service (CLAS), QZSS Multi-GNSS Advanced Orbit and Clock Augmentation-Precise Point Positioning (MADOCA-PPP), Galileo (GAL) High Accuracy Service (HAS), and BDS PPP-B2b.

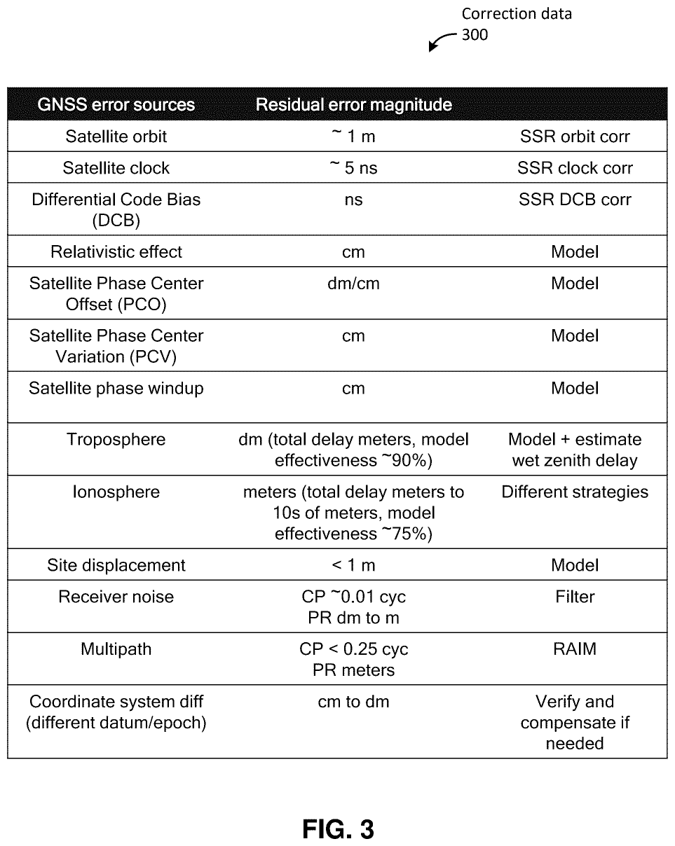

FIG. 3 is a table 300 of correction data that can be used by a PPE for high-precision position estimates, according to embodiments herein. Specifically, GNSS error sources are listed in the left-hand column, magnitude (in terms of distance or time) is provided in the center column, and correction sources are provided in the right-hand column. As can be seen, SSR can be used by a PPE to compensate for orbit, clock, and DCB errors. Other error sources can be handled through modeling or other techniques, although it can be noted that SSR data may not be limited to orbit, clock, and/or DCB correction. It can be further noted that errors may be converted between time and distance based on the speed of the RF signals (approximately the speed of light). As such, as described elsewhere herein, errors may be described in terms of distance (e.g., meters or centimeters).

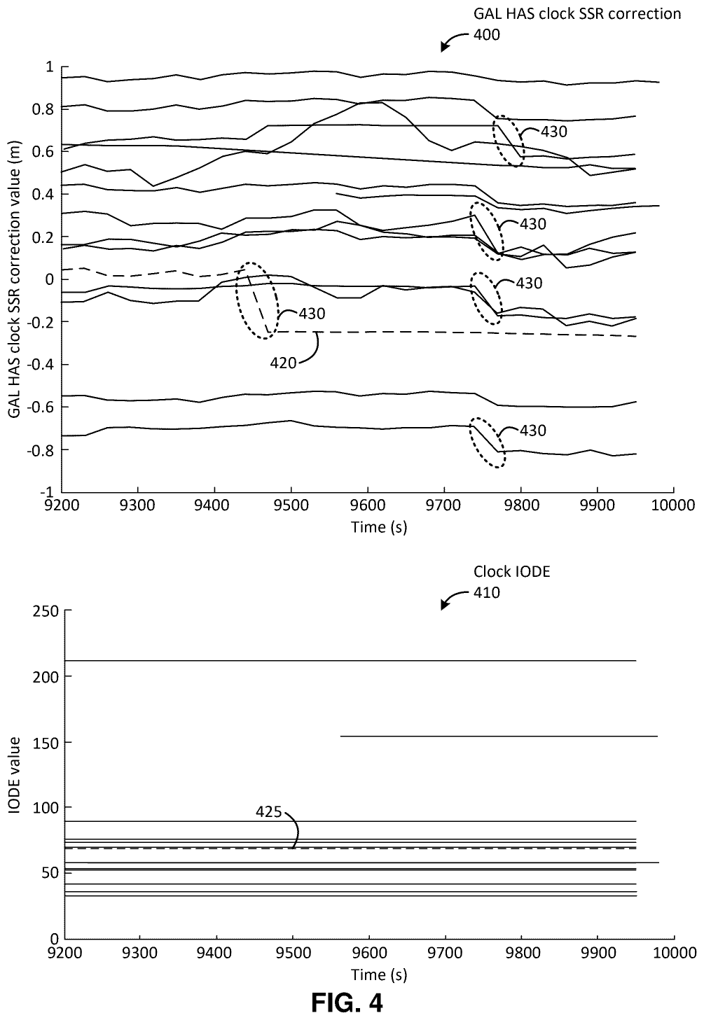

The accuracy of a GNSS-based position estimate determined by a PPE using SSR relies on the quality of SSR correction received. However, as mentioned earlier, SSR correction values may experience discontinuities, or changes in values beyond a threshold amount, from one SSR update to the next. (As described in more detail below, this threshold amount may vary, depending on desired functionality.) FIG. 4, described below, provides an example of this.

FIG. 4 is an illustration of two graphs: the first graph 400 plotting actual GAL HAS clock SSR correction data obtained for different GAL satellites over a period of time, and the second graph 410 plotting clock issue of data ephemeris (IODE) for the same period of time. As an example, plot 420 in first graph 400 represents clock SSR correction (in meters) for a particular GAL satellite, and plot 425 in second graph 410 represents the corresponding clock IODE for the particular GAL satellite.

As can be seen, clock SSR correction data in the first graph 400 can experience various discontinuities, as shown by dotted ellipses 430. (It can be noted that, to avoid clutter, only a portion of the discontinuities in graph 400 are labeled in this manner.) A PPE may apply SSR correction each epoch (e.g., one second), however, SSR correction data may be received less frequently. Clock SSR correction data, for example, may be provided every 4 to 6 seconds. As previously indicated, a discontinuity in SSR correction data occurs when there is a change in successive values of SSR correction data (e.g., from one SSR correction update to the next) beyond a threshold amount. As shown by dotted ellipses 430 in graph 400 (which identify only a portion of the discontinuities in graph 400), the data set plotted in FIG. 4 includes many discontinuities. As described in more detail below, discontinuities may be identified (e.g., as exceeding a predetermined threshold) based on the impact of the value change (e.g., in centimeters) when projected onto an LOS vector between the satellite and the approximate location of the GNSS device. In graph 400, the discontinuity in plot 420 results in a “jump” in error correction of over 15 cm, even with the same IODE.

Such discontinuities in SSR correction data can be problematic to a PPE that is not equipped for discontinuity handling. Because discontinuities may have an impact on the order of centimeters, they may not be problematic for pseudorange measurements, which are relatively imprecise (e.g., with an accuracy on the order of meters). However, for carrier phase measurements, which can be far more accurate than pseudorange measurements, such discontinuities can be problematic. In fact, a discontinuity in just one pseudorange measurement (e.g., of a single frequency band and a single satellite) can bring significant degradation in the accuracy of a position estimate determined by a PPE based on many pseudorange measurements (e.g., signals from many satellites, potentially using more than one frequency band).

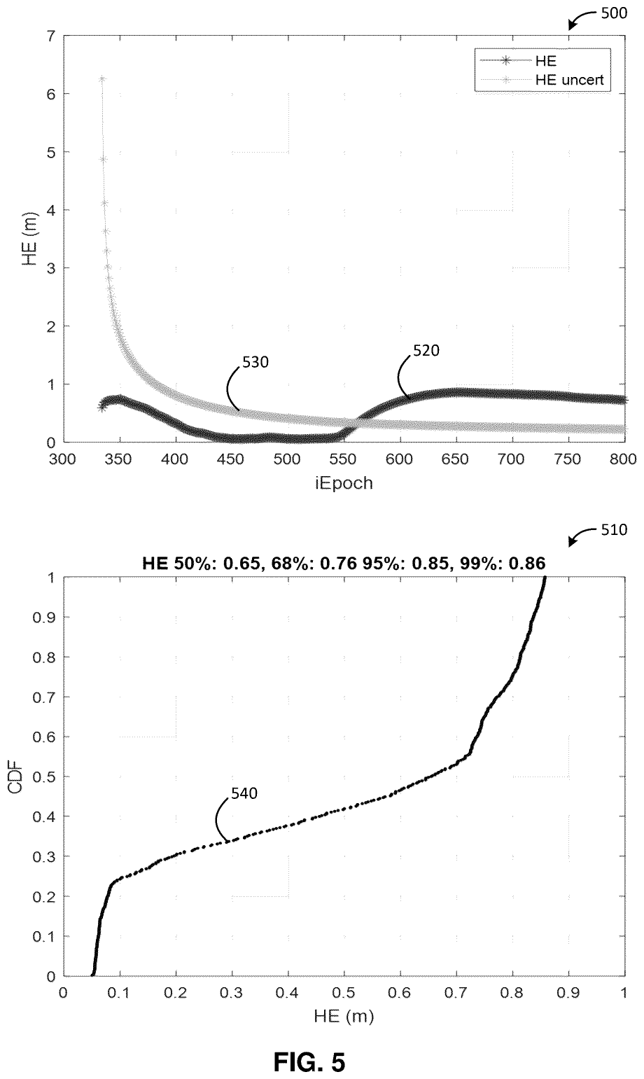

FIG. 5 is an illustration of a first graph 500 and the second graph 510 that illustrate an example of degradation in PPE performance due to a discontinuity in SSR correction data, based on simulated results. Here, the first graph 500 plots a horizontal error (HE) 520 and corresponding horizontal error uncertainty (HE uncert) 530 of a PPE position estimate over a series of epochs during which a discontinuity in SSR correction data occurs. The second graph 510 shows a cumulative distribution function (CDF) plot 540 of HE corresponding to the first graph 510.

As can be seen, discontinuity can have a negative impact on PPE performance. As shown by the first graph 500, HE 520 becomes very low (after an initial ambiguity resolution period), settling at far less than a meter. However, at approximately epoch 550, a discontinuity in SSR correction data occurs, and HE 520 climbs to nearly 1 m. The second graph 510 shows that only about 42% of values have a horizontal error of less than 0.5 m.

Embodiments herein may employ discontinuity handling to help mitigate the negative impact of SSR correction data discontinuities on PPE performance. According to some embodiments, discontinuity handling may be performed by computing the effective line-of-sight (LOS) correction delta-change value between two consecutive epochs, identifying the jump offset caused by a discontinuity in SSR correction data, and adjusting a corresponding measurement to compensate the impact from the identified jump offset. (As used herein, the term “jump offset” may refer to the effective LOS correction delta-change value resulting from a discontinuity in SSR correction data.) Additional details are provided below.

Computing the effective LOS correction delta change value between two consecutive epochs (or between successive SSR correction data updates) may be performed using the following equation:

$$Δ Corr = {Corr}_{ti} - {Corr}_{ti - 1} , \qquad ( Eqn . 1 )$$

where ΔCorr is the delta-change value between times (e.g., epochs) ti and ti-1 (e.g., in meters), and Corrₜᵢ and Corrₜᵢ₋1 are effective LOS correction values at times ti and ti-1 (e.g., in meters), respectively. In some implementations Corrₜᵢ and Corrₜᵢ₋1 may be represented as float values. Depending on the desired functionality, ΔCorr may be computed every epoch (e.g., every second) or may be computed upon receiving new SSR correction data (e.g., every 4-6 seconds).

For the effective LOS correction value at a given time (e.g., ti and ti-1), the following equation can be used:

$$Corr = LOS * ( {DCM}_{RAC}^{ECEF} * {dOrb}_{RAC} ) - dClk - dDCB , \qquad ( Eqn . 2 )$$

where LOS is the LOS vector computed with satellite position and Device Under Test (DUT) rough position,

$${DCM}_{RAC}^{ECEF}$$

is the direction-cosine rotation matrix from satellite RAC (radial, along-track, and cross-track) coordinate frame to ECEF coordinate frame, dOrb_{RAC} is the SSR orbit correction vector at RAC coordinate frame, dClk is the SSR clock correction, and dDCB is the SSR DCB correction.

As can be seen from Eqns. 1 and 2 above, ΔCorr may be calculated from Corr values for ti and ti-1 that take into account not just a single SSR correction but multiple SSR corrections (e.g., SSR orbit, clock, and DCB corrections), projected onto the LOS vector. Thus, the determination of a jump offset at a given time for a given frequency band and satellite may be the result of one or more discontinuities in SSR data at the given time for the given frequency band and satellite. Because it is the jump offset (e.g., ΔCorr above a threshold) that can cause a deterioration in PPE performance, it is the jump offset that may be analyzed to determine whether an adjustment in the PPE is needed.

The identification of a jump offset caused by an SSR correction data discontinuity may involve comparing the computed ΔCorr with a threshold value. The threshold value may vary, depending on implementation. Different PPEs may have different tolerances for jump offsets before experiencing a degradation in performance, for instance, and different applications also may have different tolerances for accuracy. According to some embodiments, the threshold value may be (substantially) 5 cm. Other embodiments may a threshold between (substantially) 3 cm to (substantially) 10 cm. Yet other embodiments may have a threshold outside of this range, depending on desired functionality.

After a jump offset is identified, an adjustment can be made in the PPE to handle the jump offset. According to some embodiments, a measurement adjustment may be made to the corresponding carrier phase measurement made by the GNSS device.

According to a first embodiment, an ambiguity term may be adjusted by the value of the jump offset (ΔCorr). For example, an SSR PPE model in which a carrier phase measurement on an Li band is described as:

$$( {Φ}_{Li} + \frac{{f}_{L 1}^{2} * δ Iono}{{f}_{Li}^{2}} ) = ρ + dT + dOrb - dClk + {ISTB}_{Li} + dTrop - \frac{{f}_{1}^{2} * {Iono}_{t 0}}{{f}_{Li}^{2}} + {λ}_{Li} ( {N}_{Li} + {r}_{Li} - {s}_{Li} ) + {ϵ}_{{Φ}_{Li}} , \qquad ( Eqn . 3 )$$

where Φ is the carrier phase measurement (m), δlono is time-variant delta-ionosphere value on the L1 band (m) (after removing this part, the ionosphere component in the individual band becomes time-invariant), ρ is the geometry range (m), dT is the receiver clock (m), dOrb is the satellite orbit error (which can be transmitted through SSR correction) (m), dClk is the satellite clock error (which can be transmitted through SSR correction) (m), ISTB is the inter/intra system/signal time biases (m), dTrop is the troposphere delay residual error after applying the model (m), lonoₜ₀ is the ionosphere delay on the L1 band at a fixed epoch at t0 (m), f is the central frequency of a specified signal band (Hz) (e.g., Li), Li is an indicator of signal band (L1, L2, L5, etc.), N is the ambiguity integer term (cycle), r is the ambiguity receiver fractional bias term (cycle), s is the ambiguity satellite fractional bias term (cycle), and e is the noise and multipath (m). An ambiguity term, A, may be defined from components of Eqn. 3 as follows:

$$A = [ - \frac{{f}_{L 1}^{2} * {Iono}_{t 0}}{{f}_{Li}^{2}} + {λ}_{Li} ( {N}_{Li} + {r}_{Li} - {s}_{Li} ) ] . \qquad ( Eqn . 4 )$$

Using this ambiguity term, Eqn. 3 may then be rewritten as:

$$( {Φ}_{Li} + \frac{{f}_{L 1}^{2} * δ Iono}{{f}_{Li}^{2}} ) = ρ + dT + dOrb - dClk + {ISTB}_{Li} + dTrop + A + {ϵ}_{{Φ}_{Li}} . \qquad ( Eqn . 5 )$$

To adjust the carrier phase measurement of Eqn. 5 to compensate for jump offset (ΔCorr), a modified ambiguity term, Ã, may be used, where:

$$\tilde{A} = A - ΔCorr . \qquad ( Eqn . 6 )$$

Using this ambiguity term, Eqn. 5 may then be rewritten as:

$$( {Φ}_{Li} + \frac{{f}_{L 1}^{2} * δ Iono}{{f}_{Li}^{2}} ) = ρ + dT + dOrb - dClk + {ISTB}_{Li} + dTrop + \tilde{A} + {ϵ}_{{Φ}_{Li}} . \qquad ( Eqn . 7 )$$

According to some embodiments, this modified carrier phase measurement (Eqn. 7) may then be used by the PPE (rather the unmodified carrier phase measurement, Eqn. 3) to determine a position estimate of the GNSS device.

According to a second embodiment, a cumulative correction term may be maintained and updated when a jump offset is detected. For example, the carrier phase measurement of carrier phase measurement Eqn. 3 can be modified to include a cumulative correction term, δCorr, as follows:

$$( {Φ}_{Li} + \frac{{f}_{L 1}^{2} * δ Iono}{{f}_{Li}^{2}} ) = ρ + dT + dOrb - dClk + {ISTB}_{Li} + dTrop - \frac{{f}_{L 1}^{2} * {Iono}_{t 0}}{{f}_{Li}^{2}} + {λ}_{Li} ( {N}_{Li} + {r}_{Li} - {s}_{Li} ) + {ϵ}_{{Φ}_{Li}} + δ Corr , \qquad ( Eqn . 8 )$$

In this second embodiment, the cumulative correction term, δCorr, may be used for positioning at each epoch. The term itself would be adjusted by an amount of a jump offset, each time the jump offset (e.g., ΔCorr above a threshold) is detected. In contrast with the first embodiment, however, this embodiment may require a buffer to store this additional cumulative correction term. That said, there may be instances in which the second embodiment may be easier to implement and, therefore, preferable to the first embodiment.

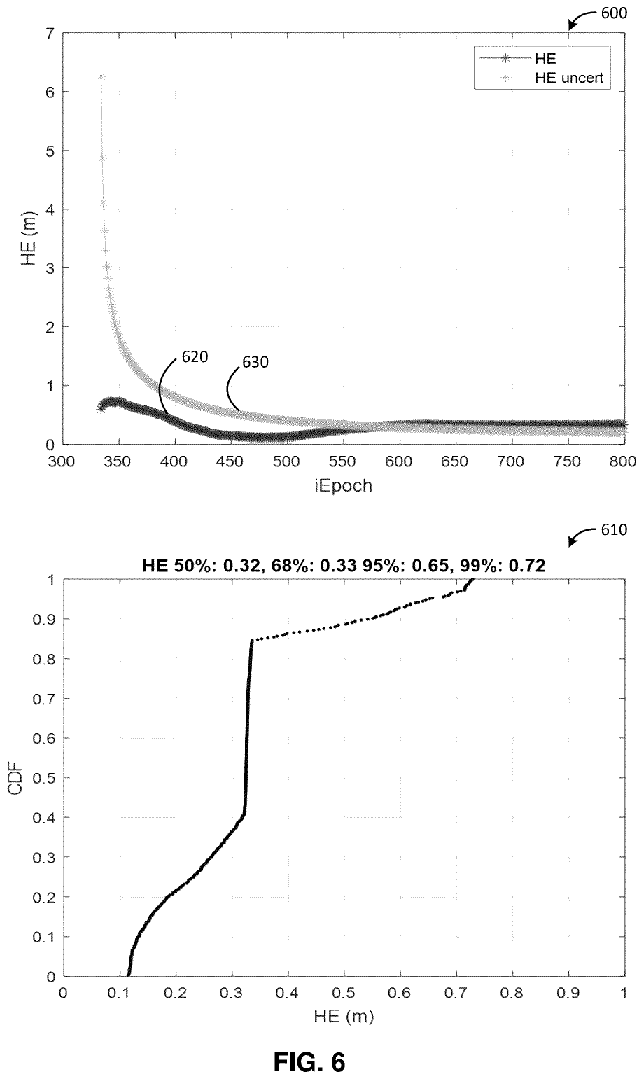

By performing SSR correction data discontinuity handling in the manner described in the embodiments above, a GNSS device can improve its position accuracy when discontinuities occur. FIG. 6 provides an example of this.

FIG. 6 is an illustration of a first graph 600 and a second graph 610 that provide an example of PPE performance when implementing SSR correction data discontinuity handling as described herein, based on simulated results. Similar to FIG. 5, the first graph 600 of FIG. 6 plots a horizontal error (HE) 620 and corresponding horizontal error uncertainty (HE uncert) 630 of a PPE position estimate over a series of epochs during which a discontinuity in SSR correction data occurs. The second graph 610 shows a cumulative distribution function (CDF) plot 540 of HE corresponding to the first graph 610. Because the graphs in FIG. 6 use the same data set as the graphs in FIG. 5, FIG. 6 may be directly compared with FIG. 5 to show the increase in performance due to SSR correction data discontinuity handling as described in the embodiments herein.

When compared to the results in FIG. 5, the results in FIG. 6 that reflect SSR correction data discontinuity handling show increased performance. Rather than approaching 1 m after epoch 550, first graph 600 of FIG. 6 shows an HE that remains at approximately 0.3 m. The second graph 610 shows that nearly 90% of position values have a horizontal error of less than 0.5 m (as opposed to only about 42% of values in graph 510).

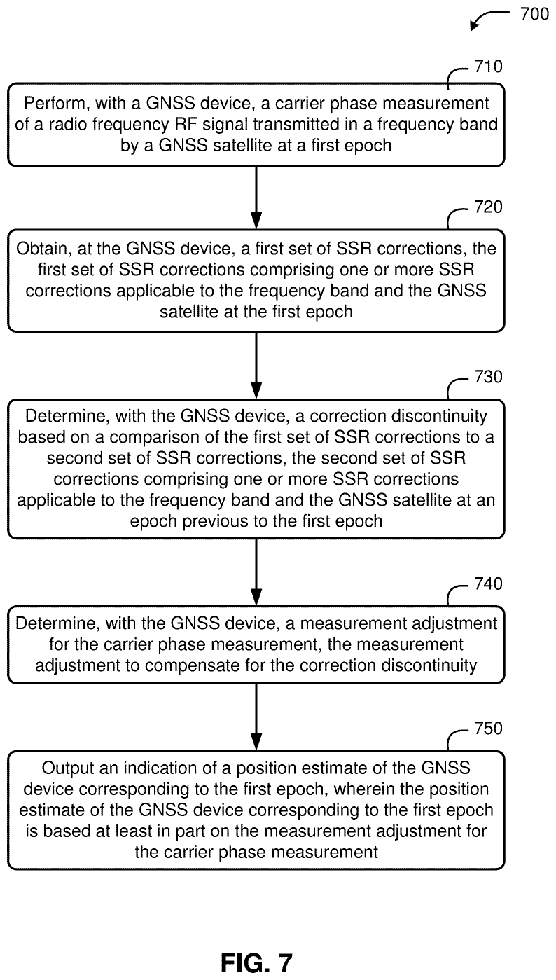

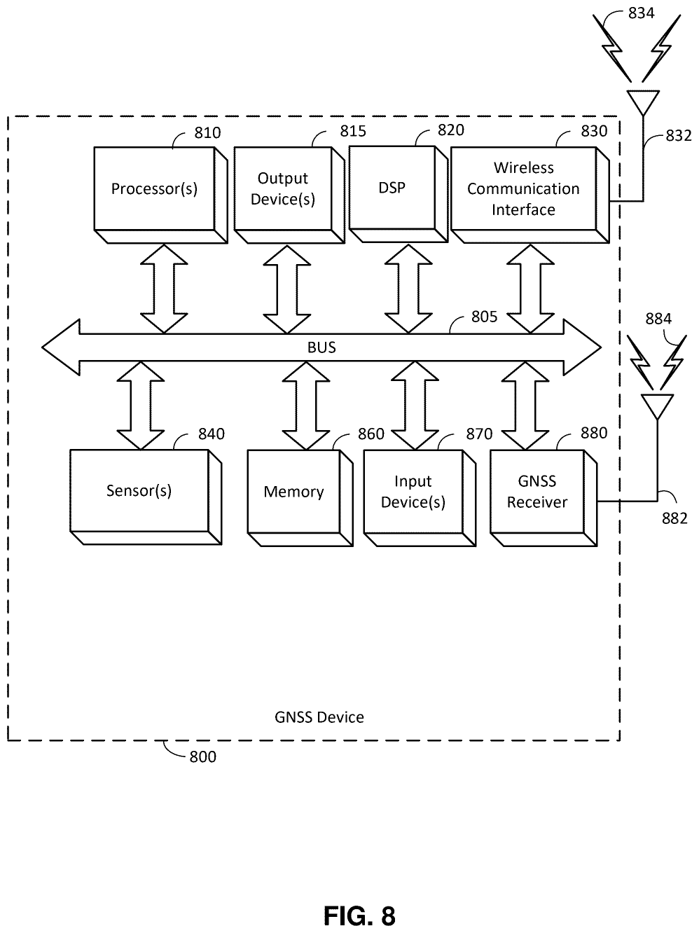

FIG. 7 is a flow diagram of a method 700 of discontinuous SSR correction handling in GNSS-based positioning, according to an embodiment. Means and/or structure for performing the functionality illustrated in one or more of the blocks shown in FIG. 7 may be performed by hardware and/or software components of a GNSS device. Example components of a GNSS device are illustrated in FIG. 8, which is described in detail below.

At block 710, the functionality comprises performing, with a GNSS device, a carrier phase measurement of a radio frequency RF signal transmitted in a frequency band by a GNSS satellite at a first epoch.

Means and/or structure for performing functionality at block 710 may comprise, for example, a bus 805, one or more processors 810, DSP 820, memory 860, GNSS receiver 880, and/or other components of a GNSS device 800 as illustrated in FIG. 8.

At block 720, the functionality comprises obtaining, at the GNSS device, a first set of SSR corrections, the first set of SSR corrections comprising one or more SSR corrections applicable to the frequency band and the GNSS satellite at the first epoch. As previously indicated, error correction (e.g., using SSR or OSR) may be provided by an error correction service, and free SSR (with regional or global coverage) is often available for at least some GNSS frequency bands from services such as QZSS CLAS, QZSS MADOCA-PPP, GAL HAS, and BDS PPP-B2b.

Means and/or structure for performing functionality at block 720 may comprise, for example, a bus 805, one or more processors 810, DSP 820, wireless communication interface 830, memory 860, GNSS receiver 880, and/or other components of a GNSS device 800 as illustrated in FIG. 8.

At block 730, the functionality comprises determining, with the GNSS device, a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch. As described in the embodiments herein, this comparison may be performed using Eqn. 1 or a similar technique to determine a delta-change value (e.g., ΔCorr) between times/epochs. As further described herein, a correction discontinuity may be determined when this delta-change value exceeds a threshold.

Means and/or structure for performing functionality at block 730 may comprise, for example, a bus 805, one or more processors 810, DSP 820, memory 860, GNSS receiver 880, and/or other components of a GNSS device 800 as illustrated in FIG. 8.

At block 740, the functionality comprises determining, with the GNSS device, a measurement adjustment for the carrier phase measurement, the measurement adjustment to compensate for the correction discontinuity. As described herein with respect to Eqns. 3-7, some embodiments may use a modified ambiguity term of the carrier phase measurements to compensate for the correction discontinuity. In some embodiments, a cumulative correction term may be used to compensate for the correction discontinuity.

Means and/or structure for performing functionality at block 740 may comprise, for example, a bus 805, one or more processors 810, DSP 820, memory 860, GNSS receiver 880, and/or other components of a GNSS device 800 as illustrated in FIG. 8.

At block 750, the functionality comprises outputting an indication of a position estimate of the GNSS device corresponding the first epoch, wherein the position estimate of the GNSS device corresponding to the first epoch is based at least in part on the measurement adjustment for the carrier phase measurement. Depending on the application, outputting the indication of the position of the GNSS device may be performed in a variety of ways. According to some embodiments, outputting the indication of the position of the GNSS device at the first epoch comprises providing the indication of the position by a GNSS receiver of the GNSS device to an application processor of the GNSS device, providing the indication of the position to an operating system or software application executed by the GNSS device, sending the indication of the position from the GNSS device to another device, or any combination thereof. In some embodiments, wherein the position estimate of the GNSS device corresponding to the first epoch is determined by a PPE executed by the GNSS device

Means and/or structure for performing functionality at block 750 may comprise, for example, a bus 805, one or more processors 810, DSP 820, one or more output devices 815, memory 860, GNSS receiver 880, and/or other components of a GNSS device 800 as illustrated in FIG. 8.

As noted in the above-described embodiments, the determination of a correction discontinuity and the adjustment of the measurement can be implemented in different ways. In some embodiments, determining the correction discontinuity may comprise determining that a difference between an LOS correction value of the first set of SSR corrections and an LOS correction value of the second set of SSR corrections exceeds a threshold value. In such embodiments, the measurement adjustment may comprise an adjustment of an effective ambiguity term of the carrier phase measurement by the difference or an adjustment of a cumulative correction term for the carrier phase measurement by the difference. The threshold value may be between substantially 3 cm and substantially 10 cm. In some embodiments, the threshold value is substantially 5 cm.

FIG. 8 is a block diagram of an embodiment of a GNSS device 800, which can be utilized as described herein above (e.g., in association with FIGS. 1-8). In some embodiments, GNSS device 800 may implement a PPE that can perform some or all of the functionality of the method 700 of FIG. 7. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 8.

The GNSS device 800 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The GNSS device 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The GNSS device 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 800 to communicate with other devices as described in the embodiments above. The wireless communication interface 830 may permit data and signaling to be communicated (e.g., transmitted and received) with base stations of a network, for example, via eNBs, gNBs, ng-eNBs, access points, and/or other access node types, and/or other network components, computer systems, and/or any other electronic devices communicatively coupled with base stations, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the GNSS device 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Arca Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The GNSS device 800 may further include and/or be in communication with a memory 860. The memory 860 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the GNSS device 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the GNSS device 800 (and/or processor(s) 810 or DSP 820 within GNSS device 800). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), crasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of discontinuous State-Space Representation (SSR) correction handling in global navigation satellite system (GNSS)-based positioning, the method comprising: performing, with a GNSS device, a carrier phase measurement of a radio frequency (RF) signal transmitted in a frequency band by a GNSS satellite at a first epoch; obtaining, at the GNSS device, a first set of SSR corrections, the first set of SSR corrections comprising one or more SSR corrections applicable to the frequency band and the GNSS satellite at the first epoch; determining, with the GNSS device, a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch; determining, with the GNSS device, a measurement adjustment for the carrier phase measurement, the measurement adjustment to compensate for the correction discontinuity; and outputting an indication of a position estimate of the GNSS device corresponding to the first epoch, wherein the position estimate of the GNSS device corresponding to the first epoch is based at least in part on the measurement adjustment for the carrier phase measurement.

Clause 2: The method of clause 1, wherein determining the correction discontinuity comprises determining that a difference between a line-of-sight (LOS) correction value of the first set of SSR corrections and an LOS correction value of the second set of SSR corrections exceeds a threshold value.

Clause 3: The method of either of clause 2, wherein the measurement adjustment comprises an adjustment of an effective ambiguity term of the carrier phase measurement by the difference.

Clause 4: The method of clause 2, wherein the measurement adjustment comprises an adjustment of a cumulative correction term for the carrier phase measurement by the difference.

Clause 5: The method of any one of clauses 2-4, wherein the threshold value is between substantially 3 cm and substantially 10 cm.

Clause 6: The method of clause 5, wherein the threshold value is substantially 5 cm.

Clause 7: The method of any one of clauses 1-6, wherein the position estimate of the GNSS device corresponding to the first epoch is determined by a precise positioning engine (PPE) executed by the GNSS device.

Clause 8: The method of any one of clauses 1-7, wherein outputting the indication of the position estimate of the GNSS device at the first epoch comprises: providing the indication of the position estimate by a GNSS receiver of the GNSS device to an application processor of the GNSS device, providing the indication of the position estimate to an operating system or software application executed by the GNSS device, sending the indication of the position estimate from the GNSS device to another device, or any combination thereof.

Clause 9: A global navigation satellite system (GNSS) device comprising: one or more GNSS receivers; one or more memories; and one or more processors communicatively coupled with the one or more GNSS receivers and the one or more memories, the one or more processors configured to: perform, with the one or more GNSS receivers, a carrier phase measurement of a radio frequency (RF) signal transmitted in a frequency band by a GNSS satellite at a first epoch; obtain a first set of State-Space Representation (SSR) corrections, the first set of SSR corrections comprising one or more SSR corrections applicable to the frequency band and the GNSS satellite at the first epoch; determine a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch; determine a measurement adjustment for the carrier phase measurement, the measurement adjustment to compensate for the correction discontinuity; and output an indication of a position estimate of the GNSS device corresponding to the first epoch, wherein the position estimate of the GNSS device corresponding to the first epoch is based at least in part on the measurement adjustment for the carrier phase measurement.

Clause 10: The GNSS device of clause 9, wherein, to determine the correction discontinuity, the one or more processors are configured to determine that a difference between a line-of-sight (LOS) correction value of the first set of SSR corrections and an LOS correction value of the second set of SSR corrections exceeds a threshold value.

Clause 11: The GNSS device of clause 10, wherein the measurement adjustment comprises an adjustment of an effective ambiguity term of the carrier phase measurement by the difference.

Clause 12: The GNSS device of clause 10, wherein the measurement adjustment comprises an adjustment of a cumulative correction term for the carrier phase measurement by the difference.

Clause 13: The GNSS device of any one of clauses 10-12, wherein the threshold value is between substantially 3 cm and substantially 10 cm.

Clause 14: The GNSS device of clause 13, wherein the threshold value is substantially 5 cm.

Clause 15: The GNSS device of any one of clauses 9-14, wherein the one or more processors are configured to determine the position estimate of the GNSS device corresponding to the first epoch using a precise positioning engine (PPE).

Clause 16: The GNSS device of any one of clauses 9-15, wherein, to output the indication of the position estimate of the GNSS device at the first epoch, the GNSS device is configured to: provide the indication of the position estimate from the one or more GNSS receivers to the one or more processors of the GNSS device, provide the indication of the position estimate to an operating system or software application executed by the GNSS device, send the indication of the position estimate from the GNSS device to another device, or any combination thereof.

Clause 17: An apparatus for discontinuous State-Space Representation (SSR) correction handling in global navigation satellite system (GNSS)-based positioning, the apparatus comprising: means for performing a carrier phase measurement of a radio frequency (RF) signal transmitted in a frequency band by a GNSS satellite at a first epoch; means for obtaining a first set of SSR corrections, the first set of SSR corrections comprising one or more SSR corrections applicable to the frequency band and the GNSS satellite at the first epoch; means for determining a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch; means for determining a measurement adjustment for the carrier phase measurement, the measurement adjustment to compensate for the correction discontinuity; and means for outputting an indication of a position estimate of a GNSS device corresponding to the first epoch, wherein the position estimate of the GNSS device corresponding to the first epoch is based at least in part on the measurement adjustment for the carrier phase measurement.

Clause 18: The apparatus of clause 17, wherein the means for determining the correction discontinuity comprises means for determining that a difference between a line-of-sight (LOS) correction value of the first set of SSR corrections and an LOS correction value of the second set of SSR corrections exceeds a threshold value.

Clause 19: The apparatus of clause 18, wherein the means for determining the measurement adjustment comprise means for determining an adjustment of an effective ambiguity term of the carrier phase measurement by the difference.

Clause 20: The apparatus of clause 18, wherein the means for determining the measurement adjustment comprise means for determining an adjustment of a cumulative correction term for the carrier phase measurement by the difference.

Clause 21: An apparatus having means for performing the method of any one of clauses 1-8.

Clause 22: A non-transitory computer-readable medium storing instructions, the instructions comprising code for performing the method of any one of clauses 1-8.

Clause 23: A device comprising: one or more transceivers; one or more memories; and one or more processors communicatively coupled with the one or more transceivers and the one or more memories, the one or more processors configured to perform the method of any one of clauses 1-8.

What is claimed is:

1. A method of discontinuous State-Space Representation (SSR) correction handling in global navigation satellite system (GNSS)-based positioning, the method comprising:
performing, with a GNSS device, a carrier phase measurement of a radio frequency (RF) signal transmitted in a frequency band by a GNSS satellite at a first epoch;
obtaining, at the GNSS device, a first set of SSR corrections, the first set of SSR corrections comprising one or more SSR corrections applicable to the frequency band and the GNSS satellite at the first epoch;
determining, with the GNSS device, a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch;
determining, with the GNSS device, a measurement adjustment for the carrier phase measurement, the measurement adjustment to compensate for the correction discontinuity; and
outputting an indication of a position estimate of the GNSS device corresponding to the first epoch, wherein the position estimate of the GNSS device corresponding to the first epoch is based at least in part on the measurement adjustment for the carrier phase measurement.

2. The method of claim 1, wherein determining the correction discontinuity comprises determining that a difference between a line-of-sight (LOS) correction value of the first set of SSR corrections and an LOS correction value of the second set of SSR corrections exceeds a threshold value.

3. The method of claim 2, wherein the measurement adjustment comprises an adjustment of an effective ambiguity term of the carrier phase measurement by the difference.

4. The method of claim 2, wherein the measurement adjustment comprises an adjustment of a cumulative correction term for the carrier phase measurement by the difference.

5. The method of claim 2, wherein the threshold value is between substantially 3 cm and substantially 10 cm.

6. The method of claim 5, wherein the threshold value is substantially 5 cm.

7. The method of claim 1, wherein the position estimate of the GNSS device corresponding to the first epoch is determined by a precise positioning engine (PPE) executed by the GNSS device.

8. The method of claim 1, wherein outputting the indication of the position estimate of the GNSS device at the first epoch comprises:
providing the indication of the position estimate by a GNSS receiver of the GNSS device to an application processor of the GNSS device,
providing the indication of the position estimate to an operating system or software application executed by the GNSS device,
sending the indication of the position estimate from the GNSS device to another device, or
any combination thereof.

9. A global navigation satellite system (GNSS) device comprising:
one or more GNSS receivers;
one or more memories; and
one or more processors communicatively coupled with the one or more GNSS receivers and the one or more memories, the one or more processors configured to:
perform, with the one or more GNSS receivers, a carrier phase measurement of a radio frequency (RF) signal transmitted in a frequency band by a GNSS satellite at a first epoch;
obtain a first set of State-Space Representation (SSR) corrections, the first set of SSR corrections comprising one or more SSR corrections applicable to the frequency band and the GNSS satellite at the first epoch;
determine a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch;
determine a measurement adjustment for the carrier phase measurement, the measurement adjustment to compensate for the correction discontinuity; and
output an indication of a position estimate of the GNSS device corresponding to the first epoch, wherein the position estimate of the GNSS device corresponding to the first epoch is based at least in part on the measurement adjustment for the carrier phase measurement.

10. The GNSS device of claim 9, wherein, to determine the correction discontinuity, the one or more processors are configured to determine that a difference between a line-of-sight (LOS) correction value of the first set of SSR corrections and an LOS correction value of the second set of SSR corrections exceeds a threshold value.

11. The GNSS device of claim 10, wherein the measurement adjustment comprises an adjustment of an effective ambiguity term of the carrier phase measurement by the difference.

12. The GNSS device of claim 10, wherein the measurement adjustment comprises an adjustment of a cumulative correction term for the carrier phase measurement by the difference.

13. The GNSS device of claim 10, wherein the threshold value is between substantially 3 cm and substantially 10 cm.

14. The GNSS device of claim 13, wherein the threshold value is substantially 5 cm.

15. The GNSS device of claim 9, wherein the one or more processors are configured to determine the position estimate of the GNSS device corresponding to the first epoch using a precise positioning engine (PPE).

16. The GNSS device of claim 9, wherein, to output the indication of the position estimate of the GNSS device at the first epoch, the GNSS device is configured to:
provide the indication of the position estimate from the one or more GNSS receivers to the one or more processors of the GNSS device,
provide the indication of the position estimate to an operating system or software application executed by the GNSS device,
send the indication of the position estimate from the GNSS device to another device, or
any combination thereof.

17. An apparatus for discontinuous State-Space Representation (SSR) correction handling in global navigation satellite system (GNSS)-based positioning, the apparatus comprising:
means for performing a carrier phase measurement of a radio frequency (RF) signal transmitted in a frequency band by a GNSS satellite at a first epoch;
means for obtaining a first set of SSR corrections, the first set of SSR corrections comprising one or more SSR corrections applicable to the frequency band and the GNSS satellite at the first epoch;
means for determining a correction discontinuity based on a comparison of the first set of SSR corrections to a second set of SSR corrections, the second set of SSR corrections comprising one or more SSR corrections applicable to the frequency band and the GNSS satellite at an epoch previous to the first epoch;
means for determining a measurement adjustment for the carrier phase measurement, the measurement adjustment to compensate for the correction discontinuity; and
means for outputting an indication of a position estimate of a GNSS device corresponding to the first epoch, wherein the position estimate of the GNSS device corresponding to the first epoch is based at least in part on the measurement adjustment for the carrier phase measurement.

18. The apparatus of claim 17, wherein the means for determining the correction discontinuity comprises means for determining that a difference between a line-of-sight (LOS) correction value of the first set of SSR corrections and an LOS correction value of the second set of SSR corrections exceeds a threshold value.

19. The apparatus of claim 18, wherein the means for determining the measurement adjustment comprise means for determining an adjustment of an effective ambiguity term of the carrier phase measurement by the difference.

20. The apparatus of claim 18, wherein the means for determining the measurement adjustment comprise means for determining an adjustment of a cumulative correction term for the carrier phase measurement by the difference.
